(19) United States
(12) Patent Application Publication
(10) Pub. No.: US 2008/0278481 A1
(43) Pub. Date: Nov. 13, 2008

(54) PHOTO GENERATED 3-D NAVIGABLE STOREFRONT

(75) Inventors: Blaise Aguera y Arcas, Seattle, WA (US); Jonathan R. Dughi, Seattle, WA (US); Randy Friedman Granovetter, Kirkland, WA (US); Jamen Shively, Seattle, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 11/949,562

(22) Filed: Dec. 3, 2007

Related U.S. Application Data
(60) Provisional application No. 60/916,717, filed on May 8, 2007.

(51) Int. Cl. G06T 15/00

(52) U.S. Cl. 345/419

(57) ABSTRACT

Presented are techniques for creating a photo-generated navigable storefront. Such techniques include receiving a images and processing the images through an image matching algorithm. Such images may include, for example, photos taken with a camera. Additionally, the images are tagged with identifier tags in order to associate related or nearby images together. Furthermore, product/service information may be associated with an image such that a selection of a particular image causes the product/service information to be displayed.

### CROSS-REFERENCE TO RELATED APPLICATION

This application claims the benefit of U.S. Provisional Application No. 60/916,717, filed May 18, 2007.

### STATEMENT REGARDING FEDERALLY SPONSORED RESEARCH OR DEVELOPMENT

Not applicable.

### BACKGROUND

Current retailers, when setting up an ecommerce site, typically use photos of the products they are selling. Often, there is little to no relationship between the photos and the physical store environment. While this has proven to be a successful model, it does not allow a retailer to immerse the consumer in their store. This model also requires a large amount of work in setting up the products, taking the photos, and building the ecommerce site. Furthermore, such a model also requires a level of effort and investment that many retailers are unwilling to spend.

Additionally, while environments like Second Life are emerging as new virtual marketplaces, they are truly virtual, meaning real photos and images are not normally represented within them, and the tools for creating these online stores are often not approachable for non-technically savvy people. The 3-D shopping environments in these virtual stores, for example, are typically hand-authored using computer modeling tools.

It may prove beneficial for sellers to have lightweight, non-technical tools that allow them to create a store environment simply from photos of the physical store. It may further prove beneficial to integrate photos of individual items directly into photos of the store environment. These techniques and methods are applicable to small stores, shops, markets, trade shows and expos. These techniques are also applicable to impromptu sales environments, such as garage sales, or to items listed sold or marketed through an online service.

### SUMMARY

This Summary is provided to introduce a selection of concepts in a simplified form that are further described below in the Detailed Description. Presented are techniques for creating a photo-generated navigable storefront. Such techniques include receiving a images and processing the images through an image matching algorithm. Such images may include, for example, photos taken with a camera. Additionally, the images are tagged with identifier tags in order to associate related or nearby images together. Furthermore, product/service information may be associated with an image such that a selection of a particular image causes the product/service information to be displayed.

### BRIEF DESCRIPTION OF THE DRAWINGS

Illustrative embodiments of the present invention are described in detail below with reference to the attached drawing figures, which are incorporated by reference herein and wherein:

FIG. 1 is a block diagram of an embodiment of an exemplary system for implementing an embodiment of the invention;

FIG. 2 illustrates an embodiment of images with identified keypoints labeled on the images according to an embodiment of the invention;

FIG. 3 illustrates an embodiment of a method 300 for presenting overlapping best neighbor images of a selected image in a UI of a 3-D photo-generated navigable image environment according to an embodiment of the invention;

FIG. 4A presents two images that illustrate an embodiment of how left and right best neighbor metrics are calculated;

FIG. 4B illustrates an embodiment of the relationship between an Image A and the Interior-Image A (AI);

FIG. 5 illustrates an embodiment of a method for presenting similar images in a 2-D photo-generated navigable image environment within a user interface;

FIGS. 6A, 6B, 6C, and 6D illustrate embodiments of a UI for presenting similar images of a selected image around the selected image in a 2-D photo-generated navigable image environment;

FIG. 7 is a flow diagram of an exemplary method for creating a photo-generated navigable storefront according to an embodiment of the invention;

FIG. 8A illustrates an embodiment of a website UI that includes a 3-D navigable image environment section and a product/service information section;

FIG. 8B illustrates an embodiment of a website UI that includes a splatter view 2-D navigable image environment section and a product/service information section;

FIG. 9 is a flow diagram of a method for managing a photo-generated navigable storefront according to an embodiment of the invention; and

FIG. 10 is a flow diagram of another method for managing a photo-generated navigable storefront according to an embodiment of the invention.

### DETAILED DESCRIPTION

The invention presented here is an extension of patent application Ser. No. 11/461,280 (hereinafter the '280 application) entitled “User Interface for Navigating Through Images.” The present invention is utilized to tie photos within a navigable 3-D environment (as described in the '280 patent) via tags to presentable online content. The concept is that a group of photos can be automatically built into a navigable 3-D environment (as described in the '280 patent), and links can be made to the photos within that environment to show dynamic content along with them. Simply by selecting different photos while walking through the 3D environment, viewers can be presented associated content—particularly product details. These details may allow them to buy a product, obtain a sample or additional information, or view related advertising. The 3D photo matching technology can be applied to moving images in a similar fashion to the way it is applied to still images; moving images may remain fixed in the 3D environment, or may be mobile.

As one skilled in the art will appreciate, embodiments of the present invention may be embodied as, among other things: a method, system, or computer-program product. Accordingly, the embodiments may take the form of a hardware embodiment, a software embodiment, or an embodiment combining software and hardware. In one embodiment, the present invention takes the form of a computer-program product that includes computer-useable instructions embodied on one or more computer-readable media.

Computer-readable media include both volatile and nonvolatile media, removable and nonremovable media, and contemplates media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. An exemplary modulated data signal includes a carrier wave or other transport mechanism. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

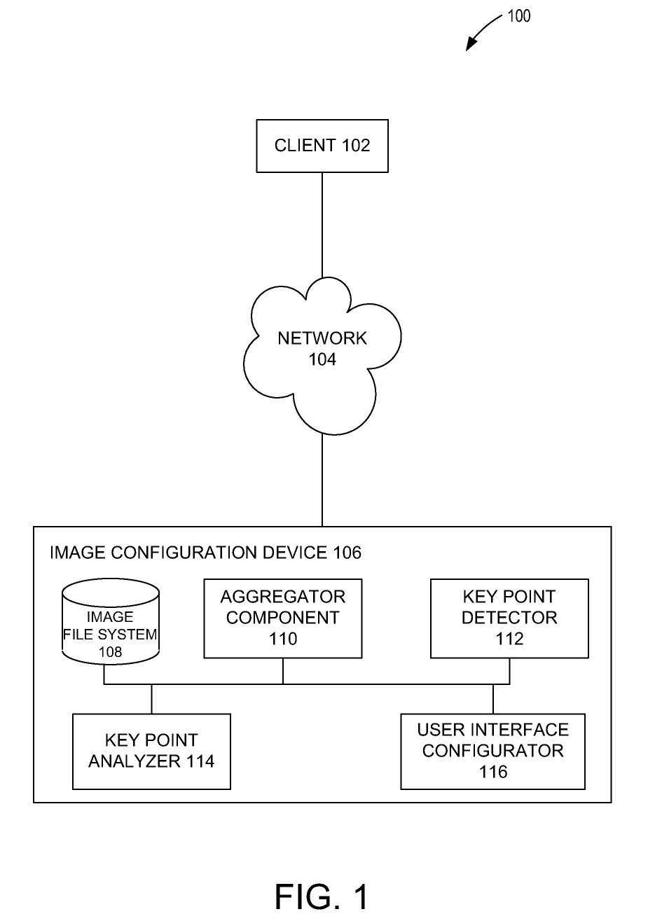

FIG. 1 is a block diagram of an embodiment of an exemplary system 100 for implementing an embodiment of the invention. The system 100 includes devices such as client 102 and image configuration device (ICD) 106. Each device includes a communication interface. The communication interface may be an interface that can allow a device to be directly connected to any other device or allows the device to be connected to another device over network 104. Network 104 can include, for example, a local area network (LAN), a wide area network (WAN), or the Internet. In an embodiment, a device can be connected to another device via a wireless interface through a the network 104.

Client 102 may be or can include a desktop or laptop computer, a network-enabled cellular telephone (with or without media capturing/playback capabilities), wireless email client, or other client, machine or device to perform various tasks including Web browsing, search, electronic mail (email) and other tasks, applications and functions. Client 102 may additionally be any portable media device such as digital still camera devices, digital video cameras (with or without still image capture functionality), media players such as personal music players and personal video players, and any other portable media device. Client 202 may also be or can include a server such as a workstation running the Microsoft Windows®, MacOS™, UniX™, Linux, Xenix™, IBM AIX™, Hewlett-Packard UX™, Novell Netware™, Sun Microsystems Solaris™, OS/2™, BeOS™, Mach™, Apache™, OpenStep™ or other operating system or platform.

### Creation of the 3-D and 2-D Photo-Generated Navigable Image Environments

As previously mentioned, the present invention is an extension of the '280 patent application. The following describes various aspects of the '280 application that may be employed by the present invention in creating a 3-D and 2-D photo-generated navigable image environment.

In an embodiment, ICD 106 may also be or can include a server such as a workstation running the Microsoft Windows®, MacOS™, UniX™, Linux, Xenix™, IBM AIX™, Hewlett-Packard UX™, Novell Netware™, Sun Microsystems Solaris™, OS/2™, BeOS™, Mach™, Apache™, OpenStep™ or other operating system or platform. In another embodiment, ICD 106 may be a computer hardware or software component implemented within client 102. The ICD 106 can include image file system 108, aggregator component 110, keypoint detector 112, keypoint analyzer 114, and user interface configurator (UIC)116. In embodiments of the invention, any one of the components (110, 112, 114, and 116) within ICD 106 may be integrated into one or more of the other components within the ICD 106. In other embodiments, one or more of the components and file system 108 within the ICD 106 may be external to the ICD 106.

The aggregator component 110 can be configured to aggregate a plurality of images uploaded by users of client machines. The images may be, in one embodiment, photographs taken with a camera (digital or non-digital). Once images are aggregated, they may be subsequently stored in image file system 108. In an embodiment, the images can be grouped and stored by similarity within the image file system 108.

In an embodiment, similarity between images can be determined using the keypoints of each image. A keypoint of an image can be used to identify points in an image that are likely to be invariant to where the image was shot from. Keypoint detector 112 can be used to detect keypoints within images. Keypoint detector 112 can use a variety of algorithms to determine keypoints within images. In an embodiment, the keypoint detector 112 may use the Scale Invariant Feature Transform (SIFT) algorithm to determine keypoints within images. Once a keypoint has been detected within an image, the keypoint can be assigned a particular identifier that can distinguish the keypoint from other keypoints. Each image along with its corresponding keypoints and the keypoints' assigned identifiers can then be stored in image file system 108.

In an embodiment, similarity between images can be determined by images that have many keypoint identifiers in common with each other. Typically, images that are taken that have the same geographic location, landmark, building, statue, object, or any other distinguishing feature depicted in the images will likely have similar or overlapping keypoints, and thus will be grouped together within image file system 108. Accordingly, there can be many groups of images stored in image file system 108 wherein each group may contain a plurality of similar images.

Keypoint analyzer 114 can be used to analyze the keypoints of each image to determine which images within each group are most similar to each other. For example, keypoint analyzer 114 can be configured to employ various algorithms to determine a ranked order of images that are most similar to a selected image. In another example, keypoint analyzer 114 may be used to determine the best neighbor image that is to the right, left, above, or below a selected image for any distance away from a selected image. Furthermore the keypoint analyzer 114 may be used to determine the best neighbor image that best represents a zoomed-in or zoomed-out version of a selected image to any degree of magnification or demagnification.

UIC 116 can be used to transmit images to a client that will present the images to a user within a user interface (UI). UIC 116 can determine which images to present and the manner in which they will be presented depending on a request from a user and any determinations made by the keypoint analyzer 114. The UIC 116 can make its determination on how to present images through use of a layout algorithm.

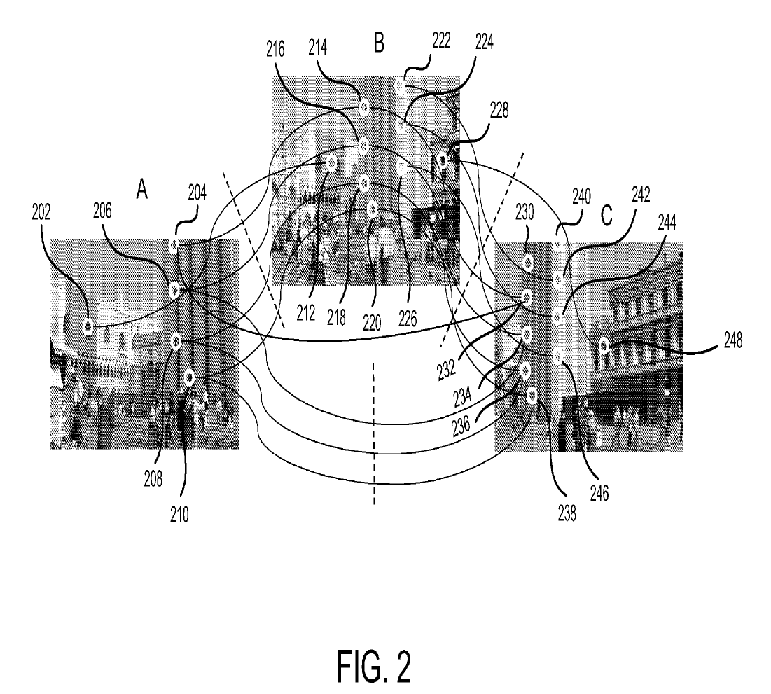

FIG. 2 illustrates an embodiment of images with identified keypoints labeled on the images according to an embodiment of the invention. Images A, B, and C each have keypoints that have been identified on them. Each keypoint within each image can have an assigned identifier, wherein identical keypoints in more than one image can have the same identifier. Image A contains keypoints 202, 204, 206, 208, and 210 that are respectively identical to keypoints 212, 214, 216, 218, and 220 in Image B. As such, each identical keypoint can have the same identifier. Keypoints 204, 206, 208, and 210 from Image A are respectively identical to keypoints 232, 234, 236, and 238 from Image C, in which each identical keypoint can have the same identifier. Keypoints 214, 216, 218, 220, 222, 224, 226, and 228 are respectively identical to keypoints 232, 234, 236, 238, 242, 244, 246, and 248, in which each identical keypoint can have the same identifier.

Once images have been uploaded and grouped into image file system 108 according to their corresponding keypoints, a user can begin to navigate through the uploaded pictures in the 3-D photo-generated navigable image environment. The invention can allow a user of a client to connect with ICD 106 in order to view one or more images stored in image file system 108. In an embodiment, the user can be presented with a UI on his client in order to select a particular image of interest from the plurality of images stored in the image file system 108. The invention can be configured to allow a user to navigate in any direction from a selected image within a UI of the user's client. When a user selects an image within the UI, there can be an option that allows the user to input a direction such as to the left, to the right, above, below, zoom-in, or zoom-out in order to navigate from the selected image to another image. Once the user selects the direction, the invention can be configured to determine a best neighbor image within the image file system 108 that best presents a representation of what is next to the selected image in the specified direction. The best neighbor image can include overlapping parts of the selected image. A best neighbor image can be determined in any direction that is to the right, left, above, or below a selected image for any distance away from the selected image. Furthermore, a best neighbor image can be determined that best represents a zoomed-in or zoomed-out version of a selected image to any degree of magnification or demagnification.

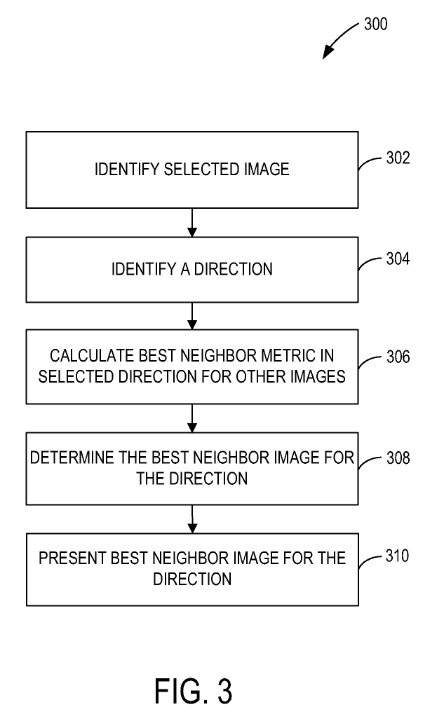

FIG. 3 illustrates an embodiment of a method 300 for presenting overlapping best neighbor images of a selected image in a UI of a 3-D photo-generated navigable image environment according to an embodiment of the invention. At operation 302, a first selected image is identified. In an embodiment, the image may be selected within the UI by a user using an input device, such as a mouse, keyboard, speech-recognition device, or touch-screen for example, of the client machine 102. At operation 304, a direction from the selected image is identified. In an embodiment, the direction may be selected by a user using an input device, such as a mouse, keyboard, speech-recognition device, or touch-screen for example, of the client machine 102. At operation 306, a best neighbor metric can be calculated for each of the other images in the image file system based on the direction. In an embodiment, the best neighbor metric can represent distance as measured by the keypoints of difference between the selected image and a compared image relative to the direction. Again, the compared image can be an image from the other images that is currently being compared to the selected image. In an embodiment, the compared image can be chosen from the images within the same group as the selected image. In another embodiment, the compared image be chosen from all images within the image file system 108.

Calculating the best neighbor metric may depend on the particular direction that is selected. In an embodiment, a different algorithm for calculating the best neighbor metric for the selected image and the compared image can be utilized for each direction. Additionally, there may be more than one type of algorithm that each direction can be configured to utilize for calculating best neighbor metrics for two images.

The two following algorithms can be used to calculate best neighbor metrics for directions to the right and to the left of a selected image respectively:

ND_{R(Sel Im, Comp Im)}=Total Keypoints_{(Rt-H Sel Im)}−Common Keypoints_{(Lt-H Comp, Rt-H Sel Im)} (1)

ND_{L(Sel Im, Comp Im)}=Total Keypoints_{(Lt-H Sel, Im)}−Common Keypoints_{(Rt-Hf Comp, Lt-H Sel Im)} (2)

Algorithm 1 calculates a best neighbor metric that represents a right neighbor distance between a selected image and a compared image. Algorithm 1 states that in order to calculate the right neighbor distance between a selected image and a compared image (“ND_{R(Sel Im, Comp Im)}”), the algorithm subtracts the total number of keypoints that the left half of the compared image and the right half of the selected image have in common (“Common Keypoints_{(Lt-H Comp, Rt-H Sel Im)}”) from the total number of keypoints identified in the right half of the selected image (“Total Keypoints_{(Rt-H Sel Im)}”).

Algorithm 2 calculates a best neighbor metric that represents a left neighbor distance between a selected image and a compared image. Algorithm 2 states that in order to calculate the left neighbor distance between a selected image and a compared image (“ND_{L(Sel Im, Comp Im)}”), the algorithm subtracts the total number of keypoints that the right half of the compared image and the left half of the selected image have in common (“Common Keypoints_{(Rt-Half Comp, Lt-H Sel Im)}”) from the total number of keypoints identified in the left half of the selected image (“Total Keypoints_{(Lt-H Sel Im)}”). Again, for both Algorithm 1 and 2, the common keypoints can be determined by identifying the keypoints within the selected image and the compared image that have the same assigned identifiers.

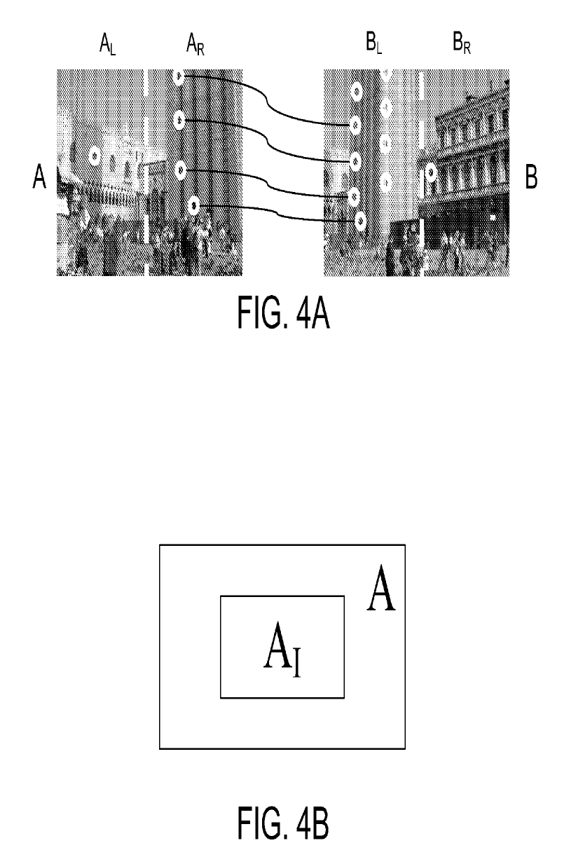

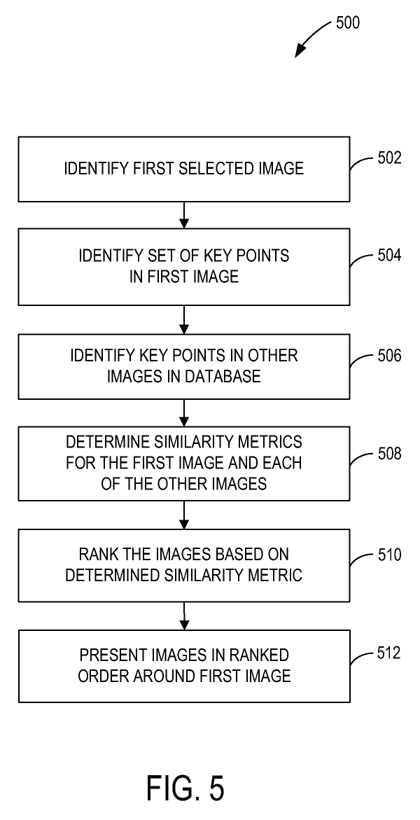

FIG. 4A presents two images that illustrate an embodiment of how left and right best neighbor metrics are calculated. First, an embodiment for calculating a right best neighbor metric will be described. Suppose that Image A is the selected image and Image B is the compared image. When calculating the right neighbor distance from Image A to Image B, each image can be divided vertically in half. The common keypoints found in the left-half of the compared image and the right-half of the selected image can be determined. In this example there are 4 common keypoints. The total keypoints found in the right-half of Image A can then be identified, which in this example is 4 keypoints. The common keypoints can then be subtracted from the total number of keypoints identified in the right-half of Image A. In this example result would be a right best neighbor metric of 0. In an embodiment, the smaller the best neighbor metric, the more the compared image is judge to be a good best neighbor for the selected direction.

Now an embodiment for calculating a left best neighbor metric will be described. Suppose Inage B is the selected image and Image A is the compared image. Again, both images can be divided vertically in half. The common keypoints found in the right-half of the compared image and the left-half of the selected image can be determined. In this example there are 4 common keypoints. The total keypoints found in the left-half of Image B can then be identified, which in this example is 9 keypoints. The common keypoints can then be subtracted from the total number of keypoints identified in the left-half of Image B. In this example result would be a right best neighbor metric of 5. Again, the smaller the best neighbor metric, the more the compared image is judge to be a good best neighbor for the selected direction. Thus, Image B may be considered to be a better right best neighbor image to Image A than Image A being a left best neighbor image to Image B.

The two following algorithms can be used to calculate best neighbor metrics for directions above and below a selected image respectively:

ND_{U(Sel Im, Comp Im)}=Total Keypoints_{(Up-H Sel Im)}−Common Keypoints_{(Lo-H Comp, Up-H Sel Im)} (3)

ND_{D(Sel Im, Comp Im)}=Total Keypoints_{(Lo-H Sel Im)}−Common Keypoints_{(Up-H Comp, Lo-H Sel Im)} (4)

Algorithm 3 calculates a best neighbor metric that represents an upper neighbor distance between a selected image and a compared image. Algorithm 3 states that in order to calculate the upper neighbor distance between a selected image and a compared image (“ND_{u(Sel Im, Comp Im)}”), the algorithm subtracts the total number of keypoints that the lower-half of the compared image and the upper-half of the selected image have in common (“Common Keypoints_{(Lo-H Comp, Up-H Sel Im)}”) from the total number of keypoints identified in the upper half of the selected image (“Total Keypoints_{(Up-H Sel Im)}”).

Algorithm 4 calculates a best neighbor metric that represents a downward neighbor distance between a selected image and a compared image. Algorithm 4 states that in order to calculate the downward neighbor distance between a selected image and a compared image (“ND_{D(Sel Im, Comp Im)}”), the algorithm subtracts the total number of keypoints that the upper-half of the compared image and the lower-half of the selected image have in common (“Common Keypoints_{(Up-H Comp, Lo-H Sel Im)}”) from the total number of keypoints identified in the lower half of the selected image (“Total Keypoints_{(Lo-H Sel Im)}”). Again, for both Algorithm 3 and 4, the common keypoints can be determined by identifying the keypoints within the selected image and the compared image that have the same assigned identifiers.

When calculating the upper and downward best neighbor metrics, the upper and lower halves of each image can be determined by dividing each image in half horizontally. However, all other calculations are done in the same exact manner when calculating the left and right best neighbor metrics as described above. In an embodiment, when identifying keypoints located in either a left-half, right-half, upper-half, or lower half of any image, if a keypoint is located directly on the dividing line of the image, the algorithms can be configured to include that keypoint as part of the total count of keypoints for the half. In other embodiments, the algorithms may be configured to disregard the keypoint from the total count of keypoints for the half.

The two following algorithms can be used to calculate best neighbor metrics for directions corresponding to zooming-out and zooming in from a selected image respectively:

ND_{O(Sel Im, Comp Im)}=Total Keypoints_{(Sel Im)}−Common Keypoints_{(Interior Comp Im, Sel Im)} (5)

ND_{I(Sel, Im, Comp Im)}=Total Keypoints_{(Interior Sel Im)}−Common Keypoints_{(Comp Im, Sel, Im)} (6)

Algorithm 5 calculates a best neighbor metric that represents an outward neighbor distance between a selected image and a compared image, wherein the outward neighbor distance can be used to represent an image that would depict a zoomed-out version of the selected image. Algorithm 5 states that in order to calculate the outward neighbor distance between a selected image and a compared image (“ND_{O(Sel, Im, Comp Im)}”), the algorithm subtracts the total number of keypoints that the interior-compared image and the entire selected image have in common (“Common Keypoints_{(Interior Comp Im, Sel, Im)}”) from the total number of keypoints identified in the entire selected image (“Total Keypoints_{(Sel Im)}”). In an embodiment, the interior-compared image can be any fraction/portion of the compared image having the same center point as the compared image. In other embodiments, the interior-compared image can have a different center point from the compared image. The interior-compared image can be, for example, a quarter of the compared image. FIG. 4B illustrates an embodiment of the relationship between an Image A and the Interior-Image A (A_{I}).

Algorithm 6 calculates a best neighbor metric that represents an inward neighbor distance between a selected image and a compared image, wherein the inward neighbor distance can be used to represent an image that would depict a zoomed-in version of the selected image. Algorithm 6 states that in order to calculate the inward neighbor distance between a selected image and a compared image (“ND_{I(Sel Im, Comp Im)}”), the algorithm subtracts the total number of keypoints that the compared image and the entire selected image have in common (“Common Keypoints_{(Comp Im, Sel Im)}”) from the total number of keypoints identified in the interior-selected image (“Total Keypoints_{(Interior Sel Im)}”). In an embodiment, the interior-selected image can be a fraction/portion of the selected image having the same center point as the compared image. In other embodiments, the interior-compared image can have a different center point as the compared image. The interior-selected image can be, for example, a quarter of the compared image. Again, for both Algorithm 5 and 6, the common keypoints can be determined by identifying the keypoints within the selected image and the compared image that have the same assigned identifiers.

In an embodiment, when identifying keypoints located within an interior image, if a keypoint is located directly on the dividing lines of the interior image, the algorithms can be configured to include that keypoint as part of the total count of keypoints for the interior image. In other embodiments, the algorithm may be configured to disregard the keypoint from the total count of keypoints for the interior image.

Referring back to FIG. 3, once the best neighbor metrics have been calculated for each of the other images, at operation 308, the best neighbor image is determined for the direction. In an embodiment, the image with the lowest best neighbor metric can be considered to be the best neighbor of the selected image for the direction. In an embodiment, when there are multiple images that have the same lowest best neighbor metric, one of those images can be randomly chosen to be the best neighbor image. In other embodiments, when there are multiple images that have the same lowest neighbor metric, a best neighbor image can be chosen by evaluating such factors such as, but not limited to, image resolution, focal lengths, camera angles, time of day when the image was taken, how recently the image was taken, and popularity of the images. In an embodiment, popularity can be determined from such factors including, but not limited to: the number of users who have selected the image; and the number of seconds users have kept the image displayed on their screens. In other embodiments, popularity can be used to determine best neighbor images in instances other than when there are multiple image with the same lowest neighbor metric. For example, popular images that would otherwise have a lower calculated best neighbor metric may be chosen as the best neighbor over images that have a higher calculated best neighbor metric. At operation 310, once the best neighbor image has been determined, the best neighbor image can be presented to the user in an UI.

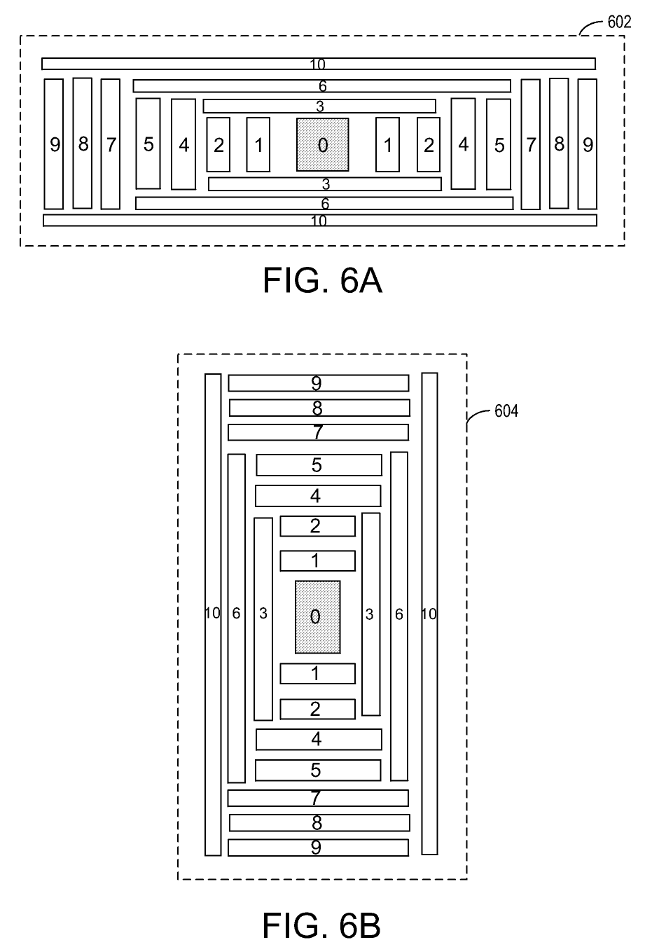

FIG. 5 illustrates an embodiment of a method 500 for presenting similar images in a 2-D photo-generated navigable image environment within a user interface according to an embodiment of the invention. The invention can allow a user of a client to connect with ICD 106 in order to view one or more images stored in image file system 108. In an embodiment, the user can be presented with a UI on his client in order to select a particular image of interest from the plurality of images stored in the image file system 108. At operation 502, a first selected image is identified. In an embodiment, the image may be selected within the UI by a user using an input device, such as a mouse, keyboard, speech-recognition device, or touch-screen for example, of the client machine 102. At operation 504, a set of keypoints within the selected image is identified. In an embodiment, if the keypoints of the selected image were previously determined when the selected image was initially aggregated into the image file system 108, identifying the keypoints can include identifying the corresponding keypoints that have been stored with the selected image. In another embodiment, identifying the keypoints in the selected image can be done on-the-fly with a keypoint detector 112 once the selected image has been selected.

At operation 506, the keypoints of other images within image file system 108 are identified. In an embodiment, the other images can include the images within the same group as the selected image. In another embodiment, the other images can include all images within the image file system 108. In an embodiment, if the keypoints of the other images were previously determined when the other images were initially aggregated into the image file system 108, identifying the keypoints can include identifying the corresponding keypoints that have been stored with each of the other images. In another embodiment, identifying the keypoints in the other images can be done on-the-fly with a keypoint detector 112 once the selected image has been selected.

At operation 508, a similarity metric can be determined for the selected image and each of the other images. A similarity metric can be used to determine a level of similarity between the selected image and each of the other images. In an embodiment, the similarity metric can represent the distance as measured by the keypoints of difference between the selected image and a compared image. The compared image can be an image from the other images that is currently being compared to the selected image. In other embodiments, the similarity metric may be determined by employing considerations of certain distance components. Such distance components may include, but is not limited to: the Euclidian distance between the camera locations for the selected image and the compared image; the angular separation between the vectors corresponding to the directions in which the selected image and the compared image were taken/photographed; and/or the difference between the focal lengths of the selected image and the compared image. Moreover, in other embodiments, the similarity metric may be determined using non-spatial distance components. Such non-spatial distance components may include, but is not limited to: image luminance, time-of-day, lighting direction, and metadata-related factors.

The invention can be configured to utilize a number of different types of algorithms for determining the various different embodiments of similarity metrics listed above. For example, several different types of algorithms can be employed when the similarity metric to be determined is the distance as measured by the points of difference between the selected image and a compared image. One such algorithm is as follows:

Dist_{(Sel Im, Comp Im)}=Total Keypoints_{(Sel Im+Comp Im)}−(2×Common KeyPoints) (7)

Algorithm 7 above states that in order to determine the distance as measured by the points of difference between the selected image and a compared image (“Dist_{(Sel Im, Comp Im)}”, the algorithm subtracts twice the number of keypoints that the selected image and a compared image have in common (“(2×Common Points)”) from the summation of the total keypoints identified in both the selected image and the compared image (“Total Keypoints_{(Sel Im+Comp Im)}”). The common keypoints can be determined by identifying the keypoints within the selected image and the compared image that have the same assigned identifiers.

FIG. 2 will now be referred to in order to illustrate examples determining a similarity metric using the above algorithm. Suppose Image A was the selected image, and Images B and C are the other images that will be compared to Image A. When Image B is the compared image, it can be determined that Image A contains keypoints 202, 204, 206, 208, and 210 that are respectively identical to keypoints 212, 214, 216, 218, and 220 in Image B. Thus, Image A and Image B have 5 common keypoints. Image A contains 5 total keypoints and Image B contains 9 total keypoints, which means that there are 14 total keypoints identified in both images. Therefore, by following Algorithm 1, the similarity metric would be 14−(2×5) which would equal to 4, wherein 4 would represent the distance as measured by the points of difference between Image A and Image B.

When Image C is the compared image, it can be determined that Image A contains keypoints 204, 206, 208, and 210 that are respectively identical to keypoints 232, 234, 236, and 238 from Image C. Thus, Image A and Image C have 4 common keypoints. Image A contains 5 total keypoints and Image C contains 10 total keypoints, which means that there are total keypoints identified in both images. Therefore, by following the Algorithm 1, the similarity metric would be 15−(2×4) which would equal to 7, wherein 7 would represent the distance as measured by the points of difference between Image A and Image C.

In determining the similarity metric for finding the distance as measured by the keypoints of difference between a selected image and a compared image, the smaller the distance between the two images, the more similar they are judged to be. For example, the distance between Image A and Image B is 4 and the distance between Image A and C is 7. Therefore, Image B is judged to be more similar to Image A than Image C is to Image A. When Algorithm 1 is applied to Image B and Image C, the distance is determined to be 3, which would mean that Images B and C are more similar to each other than each image is to Image A.

Referring back to FIG. 5, at operation 510, the other images compared to the selected image can be ranked based on their corresponding determined similarity metrics. In an embodiment, the other images can be ranked in a descending order of similarity using each image's corresponding similarity metric. Once the other images have been ranked, at operation 512, the other images can be presented in the ranked order around the selected image in a 2-D environment within a UI of the user's client.

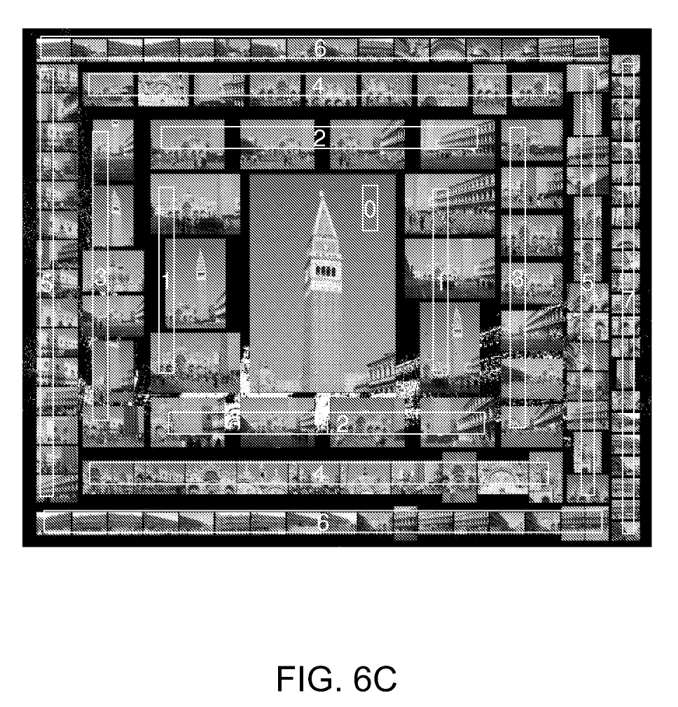

FIGS. 6A, 6B, 6C, and 6D illustrate embodiments of a UI for presenting similar images of a selected image around the selected image in a 2-D photo-generated navigable image environment. Each of FIGS. 6A-6D illustrates an organization of images called a “splatter view.” FIG. 6A illustrates an embodiment in which the ranked other images are presented in concentric bands around the selected image, wherein the selected image is represented by the image “0”. Each band can be configured to contain a specified number of other images that will be presented to a user. The other images are placed in the bands 1-10 in a descending order of similarity, wherein the other images that are the most similar to the selected image are presented nearest to the selected image. For example, the bands labeled “1” contain the other images that are the most similar to the selected image, and the bands labeled “10” contain the other images that are least similar to the selected image.

In an embodiment, each band may contain other images having corresponding similarity metrics. For example, the bands labeled “1” could contain the other images that have corresponding similarity metrics of 0, the bands labeled “2” could contain the other images that have corresponding similarity metrics of 1, the bands labeled “3” could contain the other images that have corresponding similarity metrics of 2, etc. In another embodiment, the bands could contain a range of similarity metrics. In such an embodiment, bands labeled “1” could contain other images that have similarity metrics of 0-2, bands labeled “2” could contain other images that have similarity metrics of 3-5, etc.

When presenting the images within the user's UI, the images may be presented in manner that is scaled to fit the shape of the user's screen space. As shown in FIG. 6A, the user's screen space 602 is widescreen. As such, more bands of other images are presented to the left and right of the selected image than below and above the selected image. However, as shown in FIG. 6B, a user that has a taller and narrower screen space 604 can have the concentric bands scaled to fit that type of screen space by presenting more bands above and below the selected image than to the left and the right of the selected image.

FIG. 6C illustrates another embodiment for presenting similar images of a selected image around the selected image. As shown in FIG. 6C, the images that have a higher similarity ranking are presented closer to the selected image 0 and are larger than images that are further away from the selected image 0 with lower similarity rankings.

FIG. 6D illustrates yet another embodiment for presenting similar images of a selected image around the selected image. As shown in FIG. 6D, images can be presented around the selected image in a spiral format. The most similar image, as determined by the calculated similarity metrics of each of the other images, can be presented in section “1”. The rest of the other images can be presented in a descending order of relevance in the ascending numbered sections, wherein the level of similarity of the presented images will decrease as the numbered sections increase. Again, the placement of the other images around the selected image can be determined by the corresponding similarity metric of each of the other images in relation to the selected image. Also, as shown in FIG. 6D, the images that have a higher similarity ranking (closer to the selected image) may be presented larger than images with a lower similarity ranking (further away from the selected image). In yet another embodiment, bands containing a plurality of images can be presented around the selected image in a spiral format. In such an embodiment, the bands can contain the other images that have the same similarity metric, or the bands can contain range other images that correspond to a particular range of similarity metrics; for example, the first band could contain other images that have similarity metrics between 0 and 5.

### Creation of the 3-D and 2-D Photo-Generated Navigable Storefront

Now that techniques for creating 3-D and 2-D photo-generated navigable image environments have been explained, this section will discuss the creation of a 3-D and 2-D photo-generated navigable storefront. The 3-D and 2-D photo-generated navigable storefronts can each respectively employ the 3-D and 2-D photo-generated navigable image environments discussed above. The photo-generated navigable storefront can be used by any entity that operates a commerce environment for selling goods and/or services. Such commerce environments include, but are not limited to, stores, shops, markets, trade shows, expos, a manufacturer's warehouse, and impromptu commerce environments such as garage sales.

The photo-generated navigable storefront can be incorporated into a commerce website managed by the operator of the commerce environment or an agent of the operator. The photo-generated navigable storefront can include images of products and services as they appear within the physical commerce environment. The images may be, for example, photos of the products and/or services taken with a camera (digital or non-digital). The photo-generated navigable storefront can allow users to navigate and browse through the commerce environment as if they were actually at the physical location of the commerce environment. For example, a store named “Store 1,” which may be an electronics stores having similar products and services as Best Buy, may have a website www.store1.com. The website may have “Photo-Generated Navigable Storefront” option that a user can select on the website that can allow the user to browse through a 3-D or 2-D photo-generated environment of images collected throughout Store 1 store.

In a first section of the UI of the website, there can be the actual 3-D or 2-D photo-generated navigable environment of images of the store. A user could browse the aisles of each of the departments of the store, including televisions, CDs, appliances, and video games for example, as if they were actually walking down the aisles. The user could see the actual products as they appeared on the racks of the physical store based on the images collected with a camera. In a second section of the UI of the website, there can be a webpage that presents information related to the product or service shown in an image selected by the user. For example, if a user navigated to an image that displayed a particular cell phone that was for sale, the second section could display the name, model number, and price of the phone. Additionally, information regarding different service plans that can purchased for the cell phone can also be displayed in the second section.

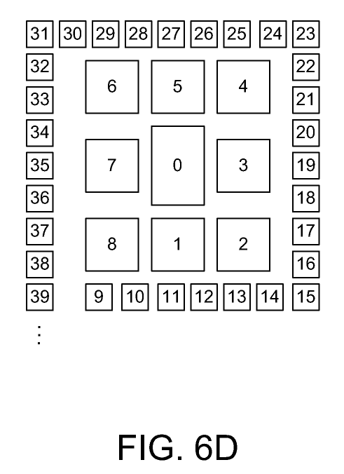

FIG. 7 is a flow diagram of an exemplary method 700 for creating a photo-generated navigable storefront according to an embodiment of the invention. At operation 702, one or more images are received. The images received may be of images of products or services taken in a commerce environment. The images may be photos of such products or services taken with a camera. In an embodiment, the images are received by an ICD 106 (FIG. 1). In such an embodiment, the images may be received by the user uploading the images from his/her camera to the ICD 106. At operation 704, each image is processed through the ICD 106. In processing the images, keypoints of each image are identified and assigned identifiers to distinguish one keypoint from another. Each keypoint identifier is associated and stored with each corresponding image in image file system 108.

At operation 706, the received images are tagged with an identifier (tag id). The tag id is an identifier that serves as link between one or more images and description information related to a product/service within the image. The related description information can be displayed in the second section of the UI of the website next to a first section of the UI that displays a navigable 3-D or 2-D photo-generated image environment. The tag id can be any word, phrase, product/service number or id, or any other descriptive mechanism for distinguishing images. The tag ids may be received manually from a user using an input device such as a keyboard or a mouse, or the tag id may be received by a user through use of a speech-recognition input system. The user could simply speak a tag id into the speech-recognition system for each corresponding image. Once the tag-id is received for an image, the tag id is associated and stored with the image in the image file system 108.

In an embodiment, a tag id is associated with a selected image based on the keypoints of the selected image. For example, instead of associating the keypoints with the image file name of a particular image, the keypoints can be associated with the tag id of the particular image. This has an added advantage such that the ICD 106 can apply the same tag id to images that have similar keypoints as the tagged image. The ICD 106 can use an algorithm for determining a threshold number of common keypoints needed to apply the same tag id from one image to another. So instead of having to manually tag each and every image uploaded into the image file system 108, a user could choose to tag one instance of an image with a particular product and that tag id can be applied to other images that contain the same product. Accordingly, once a set of related product/service information is associated with a tag id for one selected image, the same product/service information can be applied and associated with other images tagged with the same tag id.

The tag id also helps to identify when products in images, where there are multiple products in a single image, have a corresponding image within the image file system 108 that represents a closer view of a particular product. For example, a first image may contain rack in an aisle that has a Sony, a Samsung, and a Panasonic television for sale. A user may wish to see an image that shows a closer view of the Sony television but may not know how to navigate to the image of the closer view. Assuming that there is an image with a closer view of just the Sony television, if such an image has a tag id, that tag id can be associated with the region of the first image (the image that contains the Sony, Samsung, and Panasonic televisions) that shows the Sony television.

With the tag id now associated with the region of the first image, methods can be implemented to inform the user that there is an image within the image file system 108 that represents a closer view of the Sony television. For example, in one embodiment, a glowing circle or other identifier could be placed around or next to the Sony television within the first image to inform the user that there is an image of a closer view of the Sony television. In such an embodiment, if the user clicks his mouse cursor on the region of the first image that displays the Sony television, the image containing the closer view of the Sony television can be retrieved and displayed to the user. The same can be true if the other televisions within the first image have corresponding closer-view images with tag-ids. The other televisions' respective tag-ids can be associated with the region of the first image that displays the particular television, and the closer-view image can be displayed to user if the user accesses the corresponding product within the first image. In another embodiment, links to closer-view images of products displayed in larger images can be displayed in the second section of the UI of the website. For example, instead of placing some type of identifying mechanism within the 3-D or 2-D photo-generated navigable image environment for informing the user that there are closer-view images of the products within the first image, links to each closer-view image can be placed in the second section of the website UI. The closer-view image may then be presented to the user in the 3-D or 2-D photo-generated navigable image environment (first section) once he/she selects the link in the second section. Accordingly, an image with multiple products displayed in the image can have multiple tag ids associated with different areas of the image where each product is displayed.

At operation 708, the tagged images are associated with product/service information related to the products or services shown in each image. An image is associated with a set of product/service information by associating the image's tag id, or other identifier such as the image file name for example, with the with the product/service information and storing the association with the image in image file system 108. The product/service information can be stored in the image file system 108 or within a separate database that may be internal or external to ICD 106. The product/service information can include any type of multimedia data regarding a product or service being displayed in an image within the 3-D or 2-D photo-generated navigable image environment section. For example, the product/service information can include a contextual description of a product/service, a payment service for purchasing the product/service, an audio and/or video file for playing audio or video content related to the product/service, a live web cam feed of a particular area of the physical commerce environment that may or may not be related to the product/service, an instant messenger that allows the user to instant message a representative of the commerce environment, or any other item of multimedia data. In an embodiment, the second section that displays the product/service information comprises a web page to display the multimedia content.

Being that the images in the 3-D or 2-D photo-generated navigable image environment section are associated with product/service information in the second UI section, the invention can be configured such that there is two-way communication between the two sections. The two-way communication facilitates the ability for an action taken within the first UI section (3-D or 2-D photo-generated navigable image environment) to affect what is displayed in the second UI (product/service information) section and vice versa. For example, by selecting an image in the first UI section, product/service information associated with the tag id of a product within the image can be retrieved and displayed in the second UI section. An ICD 106, for example, can determine that an image or a portion of an image has been selected in the first section, identify the tag id associated with the selected image or portion, search a database containing the product/service information to retrieve a web page that has multimedia data associated with the identified tag id, and display the retrieved multimedia data in the second UI section. In another example, the second UI section can be configured to display links to closer-view images of one or more products displayed in an image in the first UI section. The selection of a particular link can cause the ICD 106, for example, to retrieve and display the closer-view image associated with the selected link in the first UI section.

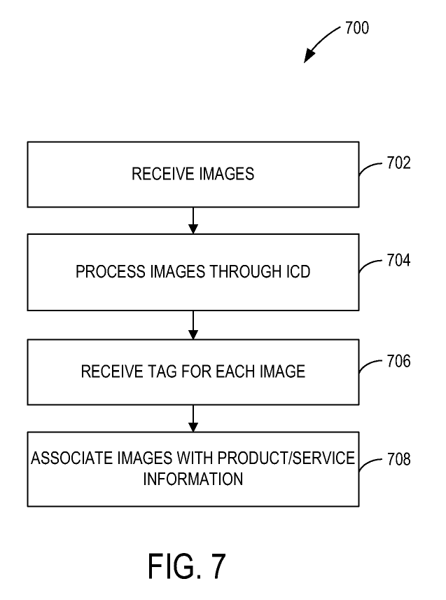

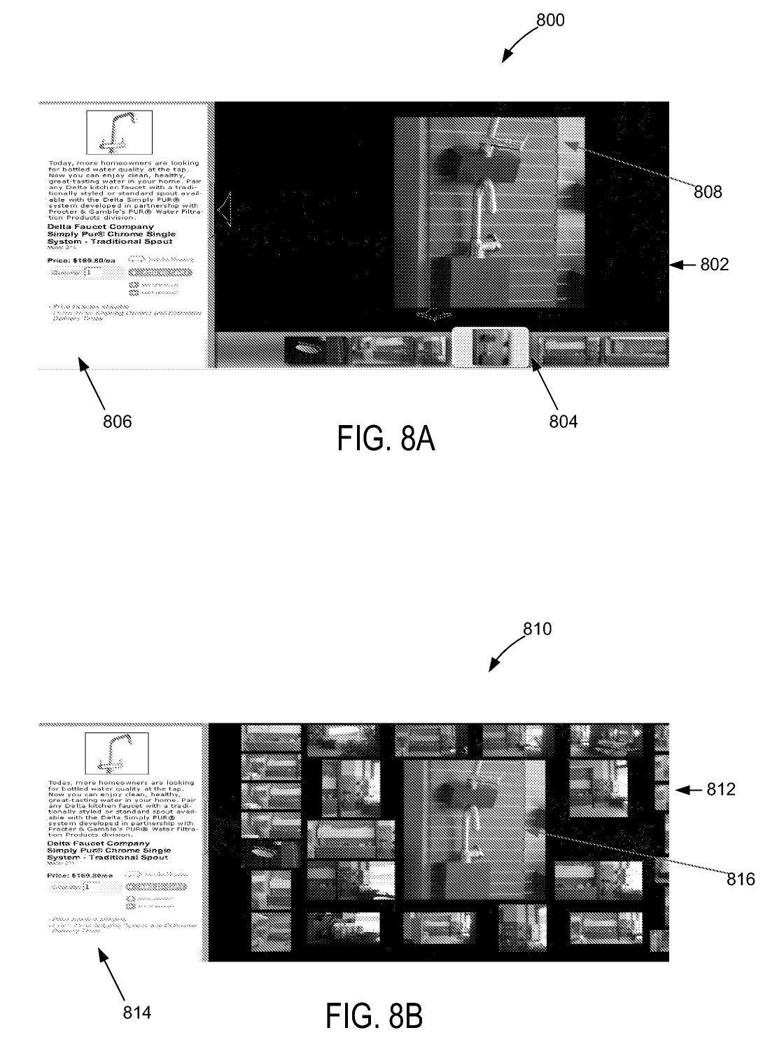

FIGS. 8A and 8B are embodiments of a website of a commerce environment for displaying a photo-generated navigable storefront. FIG. 8A illustrates an embodiment of a website UI 800 that includes a 3-D photo-generated navigable image environment section 802 and a product/service information section 806. Within the 3-D photo-generated navigable image environment 802, there may be options (not shown) that a user can select with his/her mouse cursor that allows the user to navigate to the left, right, above, below, zoom-in, or zoom-out from the selected image 808. In another embodiment, the invention may be configured to accept certain input controls from a keyboard or other input device to inform the ICD 106, for example, the direction the user wishes to navigate. Once the direction is received, the next best neighbor image can be displayed from the current selected image 808. As shown, the selection of image 808 causes product information regarding the product within image 808 to be displayed in product/service information section 806. The product information may be associated with image 808 using a tag id as described above. In an embodiment, as shown, a row of images similar to the selected image 808 may be displayed in section 804 of the 3-D photo-generated navigable image environment section 802. The images displayed in section 804 may be based on common keypoints shared with the selected image 808.

FIG. 8B illustrates an embodiment of a website UI 810 that includes a splatter view of a 2-D photo-generated navigable image environment section 812 and further includes a product/service information section 814. As shown, the selection of image 816 causes product information regarding the product within image 816 to be displayed in product/service information section 814. The product information may be associated with image 816 using a tag id as described above. In an embodiment, a selection of an image within section 812 can cause the image to be presented in the 3-D photo-generated navigable image environment. As shown in both FIGS. 8A and 8B, the product/service information section is displayed to the left of the 3-D or 2-D photo-generated navigable image environment. However, in other embodiments, the product/service information section may be displayed above, below, or to the right of the 3-D or 2-D photo-generated navigable image environment.

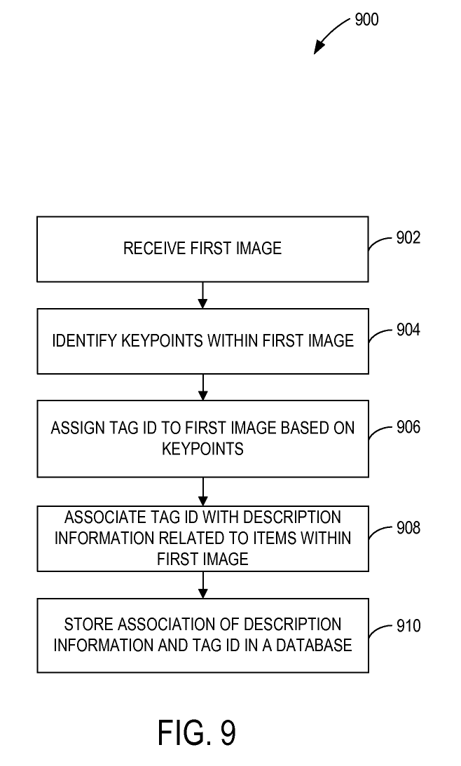

FIG. 9 is a flow diagram of a method 900 for managing a photo-generated navigable storefront according to an embodiment of the invention. At operation 902, a first image is received. In an embodiment, the first image is received by an ICD 106. The first image may be incorporated into a photo-generated navigable image environment (3-D or 2-D). At operation 904, one or more keypoints are identified within the first image. The keypoints may be identified, for example, using ICD 106. At operation 906, a tag identifier is assigned to the first image based on the keypoints of the first image. At operation 908, the tag identifier is associated with description information related to an item within the first image. At operation 910, the association of the tag identifier and the description information is stored in a database.

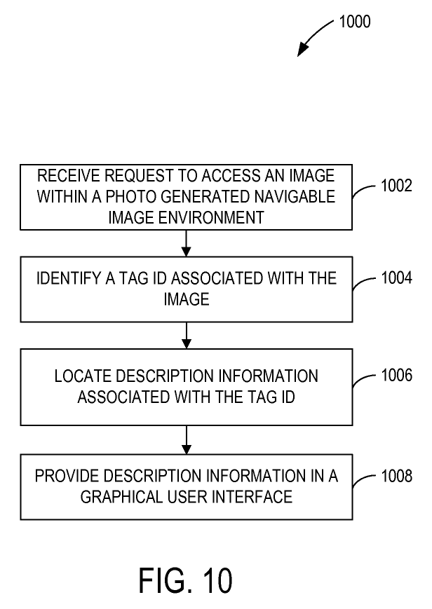

FIG. 10 is a flow diagram of another method 1000 for managing a photo-generated navigable storefront according to an embodiment of the invention. At operation 1002, a request is received to access an image within a photo-generated navigable image environment (3-D or 2-D). In an embodiment, the request is received by an ICD 106. At operation 1004, one or more tag identifiers associated with the image are identified. At operation 1006, description information associated with the tag identifiers is located. The description information may be stored, for example, in a database wherein the description location is associated with the tag identifier in the database. At operation 1008, the description information is provided in a graphical user interface.

While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations.

1. One or more computer-readable media having computer useable instructions embodied thereon for performing a method of managing a photo-generated navigable storefront, the method comprising:
receiving a first image, the first image being incorporated into a photo-generated navigable image environment;
identifying one or more keypoints within the first image;
assigning a tag identifier to the first image based on at least one of the one or more keypoints;
associating the tag identifier with description information related to at least one item within the first image; and
storing the association of the tag identifier and the description information in a database.

2. The media according to claim 1, the method further comprising providing the description information when the image is selected in the photo-generated navigable image environment.

3. The media according to claim 2, wherein the description information is provided in a separate user interface section than the photo-generated navigable image environment.

4. The media according to claim 3, wherein the description information includes a link to a second image.

5. The media according to claim 4, the method further comprising providing the second image in the photo-generated navigable image environment when the link is selected.

6. The media according to claim 1, the method further comprising assigning the tag identifier to one or more images other than the first image if the one or more other images have a predetermined number of keypoints in common with the first image, and providing the description information when at least one of the one or more other images is selected in the photo-generated navigable image environment.

7. The media according to claim 1, the method further comprising associating the description information with the first image, and providing the description information when one or more images having a predetermined number of keypoints in common with the first image is selected in the photo-generated navigable image environment.

8. The media according to claim 1, the method further comprising associating the tag id with at least one region of a third image.

9. The media according to claim 8, the method further comprising providing the description information when the region of the third image is selected within the photo-generated navigable image environment.

10. The media according to claim 9, the method further comprising providing the first image in the photo-generated navigable image environment when the region of the third image is selected.

11. One or more computer-readable media having computer-useable instructions embodied thereon for performing a method of managing a photo-generated navigable storefront, the method comprising:
receiving a request to access an image within a photo-generated navigable image environment;
identifying one or more tag identifiers associated with the image;
locating description information associated with the one or more tag identifiers; and
providing the description information in a graphical user interface.

12. The media according to claim 11, the method further comprising:
identifying one or more other images with a predetermined number of keypoints in common with the image; and
providing the one or more other images in the graphical user interface with the image.

13. The media according to claim 11, wherein the photo-generated navigable image environment is provided in a first section of the graphical user interface and the description information is provided in a second section of the graphical user interface.

14. The media according to claim 11, wherein the description information includes a link to a second image.

15. The media according to claim 14, the method further comprising providing the second image in the photo-generated navigable image environment when the link is selected.

16. A graphical user interface embodied on one or more computer-readable media and executable on a computer for presenting on a display screen a photo-generated navigable storefront, the graphical user interface comprising:
a first screen area configured to display a photo-generated navigable image environment including at least one image; and
a second screen area configured to display description information related to at least one item within the at least one image when the at least one image is selected.

17. The graphical user interface according to claim 16, wherein the first screen area displays one or more other images that have a predetermined number of keypoints in common with the at least one image.

18. The graphical user interface according to claim 16, wherein the at least one image is displayed in the photo-generated navigable image environment when a region of a second image is selected, wherein the region of the second image is associated with a tag identifier of the at least one image.

19. The graphical user interface according to claim 16, wherein the description information includes a link to a third image.

20. The graphical user interface according to claim 19, wherein the third image is displayed in the first screen area when the link is selected.
